(19) United States
(12) Patent Application Publication
(10) Pub. No.: US 2018/0354507 A1
(43) Pub. Date: Dec. 13, 2018

(54) REAR COLLISION REDUCTION BY TORQUE OVERRIDE

(71) Applicant: Continental Automotive Systems, Inc., Auburn Hills, MI (US)

(72) Inventor: Sean Patrick Slattery, Waterford, MI (US)

(73) Assignee: Continental Automotive Systems, Inc., Auburn Hills, MI (US)

(21) Appl. No.: 15/617,226

(22) Filed: Jun. 8, 2017

(51) Int. Cl. B60W 30/09; B60W 10/18; B60W 10/06; B60W 10/08

(52) U.S. Cl. CPC B60W 30/09; B60W 10/18; B60W 10/06; B60W 10/08; B60W 20/40; B60W 2420/62; B60W 2420/54; B60W 2550/10; B60W 2420/52

(57) ABSTRACT

A collision avoidance system for a vehicle, which includes at least one sensor mounted to the vehicle, the sensor being operable for detecting the approach of a second vehicle towards the rear of the vehicle. The vehicle also includes a braking system which is operable for allowing or preventing the rotation of one or more wheels of the vehicle, and a propulsion component, such as an internal combustion engine. The braking system releases the wheels, and the engine moves the vehicle when the sensor detects the approach of the second vehicle towards the rear of the vehicle. The rear collision avoidance system using torque override may be applicable with a vehicle having other sources of propulsion, such as an electric motor used as part of a hybrid electric vehicle or battery electric vehicle.

### FIELD OF THE INVENTION

The invention relates generally to avoiding a collision to the rear of the vehicle by releasing brake force and using engine torque to propel the vehicle forward.

### BACKGROUND OF THE INVENTION

There are millions of rear-end collisions which occur on roadways every year, which may cause serious injuries, and in some cases are fatal. Currently, there are rear collision systems designed to protect the vehicle passengers. These current systems include features such as driver warning of the collision, pre-tightening of the seat belt, changing the position of the head rest, and increasing brake pressure to apply more braking force to the wheels to reduce the amount of vehicle movement after rear impact. However, none of these features function to reduce the impact of the rear collision, or avoid the collision altogether.

Accordingly, there exists a need for a system which is able to reduce or eliminate rear-end collisions to a vehicle.

### SUMMARY OF THE INVENTION

In one embodiment, the present invention is a collision avoidance system for a vehicle, which includes at least one sensor mounted to the vehicle, the at least one sensor being operable for detecting the approach of a second vehicle towards the rear of the vehicle. The vehicle also includes a braking system which is operable for allowing or preventing the rotation of one or more wheels of the vehicle. The vehicle also includes a propulsion component, which in one embodiment is an internal combustion engine. However, it is within the scope of the invention that the rear collision avoidance system using torque override may be applicable with vehicle having other sources of propulsion, such as an electric motor used as part of a hybrid electric vehicle or battery electric vehicle. The braking system releases the wheels, and the engine moves the vehicle when the sensor detects the approach of the second vehicle towards the rear of the vehicle.

The vehicle also includes a brake control module operable for controlling the braking system, and a control module operable for controlling the engine. The brake control module is in electrical communication with the sensor, and the engine control module is in electrical communication with the brake control module. When the sensor detects the approach of the second vehicle towards the rear of the vehicle, the brake control module commands the brake system to allow rotation of the wheels, and the control module commands propulsion from the engine to move the vehicle, to avoid or lessen the impact of the collision of the second vehicle into the vehicle.

The collision avoidance system of the present invention also includes an additional collision avoidance feature. The additional collision avoidance feature includes a second sensor operable for detecting one or more objects in an area around the front of the vehicle. When the second sensor detects one or more objects in an area around the front of the vehicle, the braking system prevents the rotation of the one or more wheels, and the control module does not command the engine to propel the vehicle forward.

The objects detected by the second sensor may be additional vehicles approaching from different directions, or pedestrians walking across the road.

The first and second sensors may be any suitable sensor for detecting the presence of other vehicles or pedestrians, such as, but not limited to a laser, a LIDAR sensor, a LADAR sensor, radar, and sonar.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of a vehicle at an intersection which has a rear collision avoidance system using torque override, according to embodiments of the present invention; and

FIG. 2 is a diagram of a vehicle which has a rear collision avoidance system using torque override, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

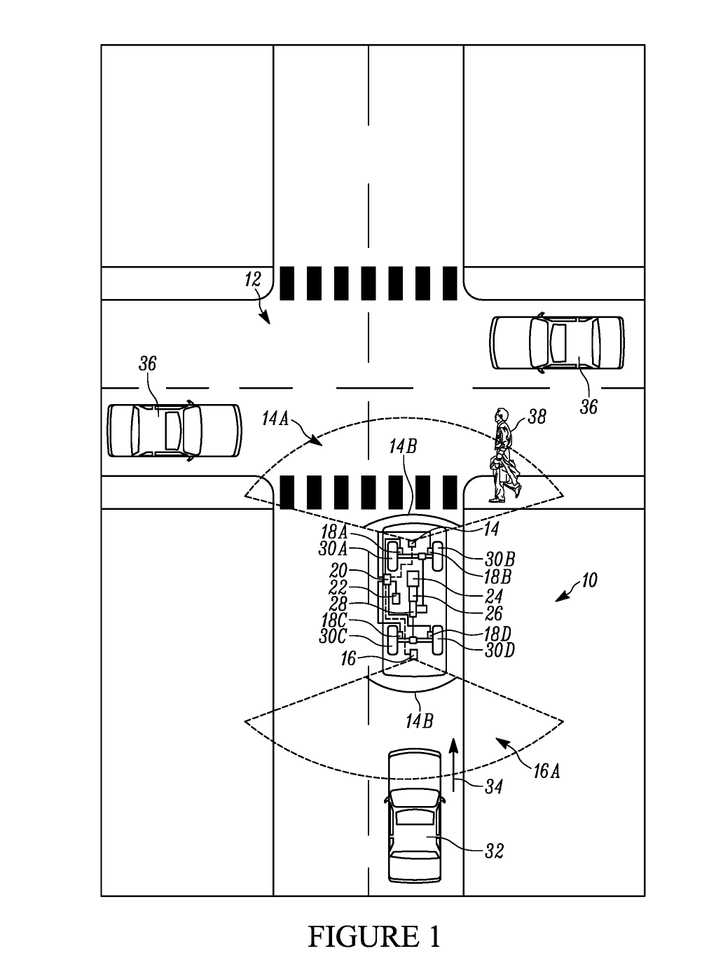

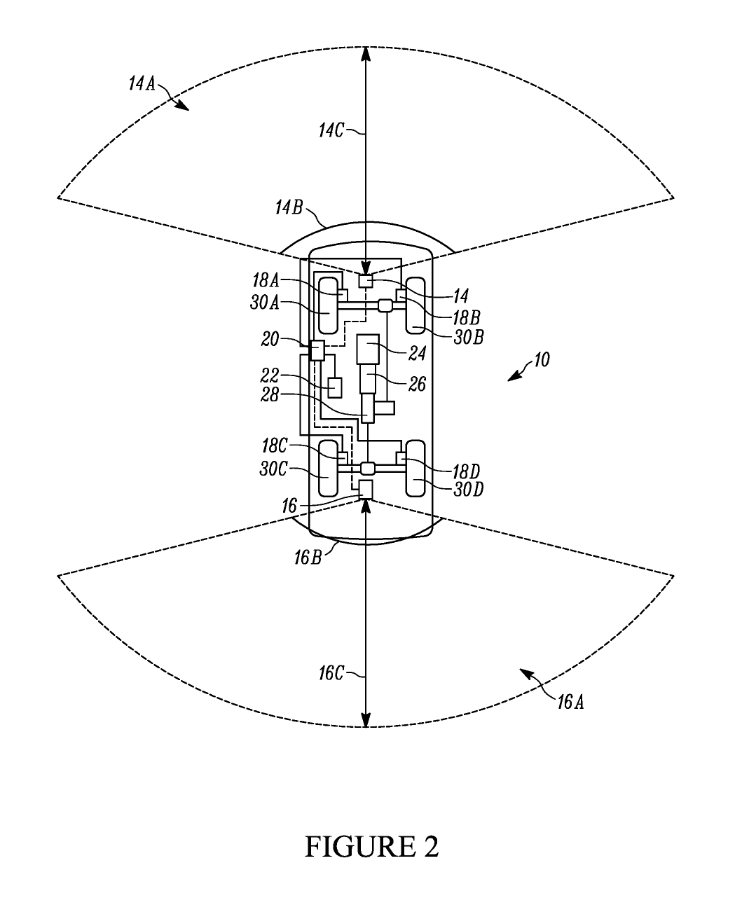

A vehicle having a rear collision avoidance system using torque override is shown in FIGS. 1 and 2, generally at 10. In this embodiment, the vehicle 10 is stopped at an intersection, shown generally at 12. The vehicle 10 includes several sensors used for detecting various objects and interpreting the environment around the vehicle 10. In this embodiment, the vehicle 10 includes a front radar 14 and a rear radar 16. The front radar 14 is used for detecting various objects in front of the vehicle 10 in the detection area, shown generally at 14A, and the rear radar 16 is used for detecting various objects behind the vehicle 10 in the detection area shown generally at 16A. The size of the detection areas 14A,16A varies, depending upon the type of sensor used. The detection areas 14A,16A each have a span angle 14B,16B and a radius 14C,16C where objects are detected. Furthermore, more than one sensor, such that there may be duplicates of the radars 14,16 used along the front and rear of the vehicle 10, and may be mounted in different positions to change the size and shape of each of the detection areas 14A,16A.

The vehicle 10 also includes a brake system, which includes several brake units 18A,18B,18C,18D, which are in electrical communication with a brake control module, which in this embodiment is an electronic brake system (EBS) module 20. Each brake unit 18A,18B,18C,18D allows or prevents the rotation of a corresponding wheel 30A,30B,30C,30D.

The EBS module 20 is in electrical communication with a control module, which in this embodiment is an electronic control unit (ECU) 22, where the ECU 22 controls the various powertrain components of the vehicle 10, such as the engine 24, transmission 26, and transfer case 28.

There is also a second vehicle 32 traveling towards the vehicle 10 in the direction shown by the arrow 34. During operation, the brake units 18A,18B,18C,18D maintain the vehicle 10 in a stopped position when the vehicle 10 is stopped at the intersection 12. The radars 14,16 are constantly detecting if there are objects in the respective detection areas 14A,16A. If the rear radar 16 detects that the second vehicle 32 is approaching the vehicle 10 at a rate of speed such that the second vehicle 32 cannot stop in time to avoid colliding with the vehicle 10, a signal is sent to the EBS module 20 to release the braking units 18A,18B,18C,18D. At the same time, the EBS module 20, also communicates with the ECU 20, and the ECU 20 commands the engine 24 to propel the vehicle 10 forward. The engine 24 then transfers power to the transmission 26 and therefore the transfer case 28, which then transfers power to and rotates the wheels 30A,30B,30C,30D, moving the vehicle 10 forward. This provides the second vehicle 32 an increased amount of distance and time to come to a complete stop. If the second vehicle 32 is travelling at such a rate of speed that a collision is unavoidable, the movement of the vehicle 10 forward reduces the magnitude of the impact when the vehicles 10,32 collide.

The rear collision avoidance system having torque override of the present invention also includes an additional collision avoidance feature. When the vehicle 10 is stopped at the intersection 12, the front radar 14 detects any objects in the detection area 14A, such that any additional vehicles 36 approaching the intersection 12 may be detected. If the front radar 14 detects that one or more of the additional vehicles 36 is going to be in proximity to the vehicle 10 if the vehicle 10 is moved forward such that there is a danger of one of the additional vehicles 36 colliding with the vehicle 10, this is communicated to the EBS module 20 and the ECU 22, such that the engine 24 is not commanded to propel the vehicle 10 forward, and the brake units 18A,18B,18C,18D maintain the vehicle 10 in the stopped position at the intersection 12. The front radar 14 is not only used for detecting the additional vehicles 36, but the front radar 14 may also be used for detecting if there are pedestrians 38 in the detection area 14A as well, such that the vehicle 10 is not moved forward, avoiding a collision with the pedestrians 38.

Although in the example described, the rear collision avoidance system using torque override of the present invention is used at the intersection 12 as described above, it is within the scope of the invention that the rear collision avoidance system using torque override of the present invention may be used in any type of driving conditions to avoid a rear collision to the vehicle 10. For example, if the vehicle 10 is stopped on a roadway or highway due to high traffic volumes, the vehicle 10 may be moved forward if the vehicle 10 is being approached by and is in danger of a rear-end collision with an oncoming vehicle.

In the embodiments described above, the sensors used are the front radar 14 and the rear radar 16, which detect any objects that are present in the corresponding detection areas 14A,16A. However, it is within the scope of the invention that other types of sensing devices may be used, such as, but not limited to, LIDAR (Light Imaging, Detection, and Ranging), LADAR (Laser Imaging, Detection, and Ranging), or sonar.

The rear collision avoidance system using torque override of the present invention has been described for use with an engine 24, which in this embodiment is an internal combustion engine 24. However, it is within the scope of the invention that the rear collision avoidance system using torque override may be applicable with vehicle having other sources of propulsion, such as an electric motor used as part of a hybrid electric vehicle or battery electric vehicle. In these embodiments, the ECU 22 is in communication with and controls one or more electric motors used to provide propulsion torque to the vehicle 10. If there are no other vehicles 36 or pedestrians 38 approaching the intersection 12, and the second vehicle 32 is approaching the vehicle 10 such that if the vehicle 10 remains stopped at the intersection 12, a collision between the vehicles 10,32 is going to occur. The impending collision with the rear of the vehicle 10 by the second vehicle 32 is detected by the rear sensor 16, the ECU 22 commands the electric motors to propel the vehicle 10 forward, reducing the magnitude of the collision with the second vehicle 32, or completely preventing the collision.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A collision avoidance system for a vehicle, comprising:
at least one sensor mounted to the vehicle, the at least one sensor being operable for detecting the approach of a second vehicle towards the rear of the vehicle;
a braking system being part of the vehicle, the braking system operable for allowing or preventing the rotation of one or more wheels of the vehicle; and
a propulsion component operable for moving the vehicle;
wherein the braking system releases the one or more wheels, and the propulsion component moves the vehicle when the at least one sensor detects the approach of the second vehicle towards the rear of the vehicle.

2. The collision avoidance system for a vehicle of claim 1, further comprising:
a brake control module operable for controlling the braking system, the brake control module in electrical communication with the at least one sensor; and
a control module operable for controlling the propulsion component, the control module in electrical communication with the brake control module;
wherein as the at least one sensor detects the approach of the second vehicle towards the rear of the vehicle, the brake control module commands the brake system to release the one or more wheels, and the control module commands propulsion from the propulsion component to move the vehicle forward.

3. The collision avoidance system for a vehicle of claim 1, further comprising an additional collision avoidance feature.

4. The collision avoidance system for a vehicle of claim 3, the additional collision avoidance feature further comprising:
a second sensor operable for detecting one or more objects in an area around the front of the vehicle;
wherein the braking system prevents the rotation of the one or more wheels when the second sensor detects one or more objects in the area around the front of the vehicle.

5. The collision avoidance system for a vehicle of claim 4, the one or more objects being one selected from the group consisting of additional vehicle and pedestrians.

6. The collision avoidance system for a vehicle of claim 1, the propulsion component further comprising an engine.

7. The collision avoidance system for a vehicle of claim 1, the propulsion component further comprising at least one electric motor.

8. The collision avoidance system for a vehicle of claim 1, wherein the at least one sensor is one selected from the group consisting of a laser, a LIDAR sensor, a LADAR sensor, radar, and sonar.

9. A rear collision avoidance system using torque override, comprising:
a plurality of sensors mounted to a vehicle, a first of the plurality of sensors operable for detecting the approach of a second vehicle towards the rear of the vehicle, a second of the plurality of sensors operable for detecting one or more objects in an area around the front of the vehicle;
a braking system operable for allowing or preventing the rotation of a plurality wheels of the vehicle;
a brake module operable for controlling the braking system, each of the plurality of sensors in electrical communication with the brake module;
a propulsion component operable for moving the vehicle;
a control module operable for controlling the propulsion component, the control module in electrical communication with the brake control module;
wherein the brake module commands the braking system to release the plurality of wheels, and the control module commands the propulsion component to move the vehicle when the first of the plurality of sensors detects the approach of the second vehicle towards the rear of the vehicle, and the second of the plurality of sensors detects there are none of the one or more objects in the area around the front of the vehicle.

10. The rear collision avoidance system using torque override of claim 9, the propulsion component further comprising an engine.

11. The rear collision avoidance system using torque override of claim 9, the propulsion component further comprising at least one electric motor.

12. The rear collision avoidance system using torque override of claim 9, wherein the braking system prevents the rotation of the one or more wheels when the second of the plurality of sensors detects one or more objects in the area around the front of the vehicle.

13. The rear collision avoidance system using torque override of claim 9, wherein the at least one sensor is one selected from the group consisting of a laser, a LIDAR sensor, a LADAR sensor, radar, and sonar.
